(19) United States
(12) Patent Application Publication
(10) Pub. No.: US 2006/0062373 A1
(43) Pub. Date: Mar. 23, 2006

(54) Call center agent presence verification

(76) Inventors: Steven Chervets, N. Andover, MA (US); James A. Kotelly, Pepperell, MA (US)

Correspondence Address: CHAPIN & HUANG L.L.C.;WESTBOROUGH OFFICE PARK, 1700 WEST PARK DRIVE, WESTBOROUGH, MA, 01581, US

(21) Appl. No.: 10/947,698

(22) Filed: Sep. 23, 2004

(51) Int. Cl. H04M 3/00; H04M 5/00

(52) U.S. Cl. 379/265.03; 379/265.11

(57) ABSTRACT

In response to a customer call to a call center, an available agent is selected and the call is connected to the selected agent. Initially it is determined whether voice is present in the connection from the agent to the customer within a predetermined time interval, e.g. 3-6 seconds, by calculating the energy in media packets and comparing this value with a predetermined threshold. If no voice is present from the agent, the call is re-routed to another agent. Additionally, the agent may be marked as not available for subsequent calls, and the agent can be so notified. The “agent not present” event may be reported to a supervisor who may contact the agent or further monitor the agent to ascertain whether the non-responsiveness recurs. The technique can be used with “local” agents (those physically present in the call center) and with “remote” agents (those connected to the call center, e.g. via the public switched telephone network (PSTN)). A persistent call can be established between remote agents and the call center to be used for a number of customer calls. In this case, the customer call is connected to the persistent call.

### BACKGROUND

The present invention is related to the field of call center systems.

In call center systems, the availability of service representatives or “agents” to accept customer telephone calls is made known to a call center controller (also known as an automatic call distributor (ACD)) via a “login” operation at a computer-telephony interface (CTI). The agent identifies himself or herself via a login screen, and the controller associates the agent with a telephone number of a telephone via which the agent can be reached. Many call center systems employ so-called “Internet Protocol” (IP) or packet-based telephony, in which case the agent's telephone is identified by an IP address in much the same way as a computer device. Using a CTI screen, the agent signals that he/she is in an “available” state. When the controller subsequently selects the agent to handle a particular customer call, it routes the call to the agent's phone using the phone's IP address. If the agent subsequently needs to take a break, leave for the day, etc., the agent again uses the CTI screen to signal to the controller that he/she is now in an “unavailable” state, in which case the controller does not include the agent in the pool from which agents are selected to handle calls.

The agent's phone may be configured in one of multiple ways. It may be configured to be operated in a traditional fashion in which it rings (or otherwise gives notification of an incoming call) and the agent answers it (i.e., generates an “off-hook” or “answered” signal). The agent's phone may alternatively be configured to “auto-answer”, i.e., to be automatically connected to the line as soon as a call is received. This configuration can be more convenient for agents because there is no need to take action to receive a call—the agent receives a ringing tone or other notification that a call is coming in, and then the call just starts immediately thereafter. It is presumed, of course, that the agent is using a headset or similar device that can readily couple the agent to the line without requiring any physical manipulation by the agent such as would be required with a handset, for example.

### SUMMARY

One problem in call centers is the possibility that an agent who is indicated to be “available” actually becomes absent or otherwise does not respond to customer calls when directed to him/her. For example, an agent may take a break and inadvertently forget to signal to the controller that he/she is now “unavailable.” In such cases, the controller continues to route customer calls to the agent, but he/she never answers. This may not be especially problematic if the agent's phone is not configured for auto-answering. In this case, a signal known as “ring no answer” is automatically generated by the phone, and upon receiving this signal the controller can re-route the call to another agent. However, when the agent's phone is configured for auto-answering, the “ring no answer” signal is not generated. Instead, the call is automatically connected to the agent's phone, but no agent is there. The customer does not hear any greeting, and eventually may hang up, abandoning the call.

In accordance with the present invention, a technique is disclosed for handling customer calls in a call center for providing improved call center services, including reducing the incidence of abandoned customer calls and better overall supervision of the performance of call center agents. The disclosed technique can be used with both “local” (i.e., located at the call center) agents as well as “remote” agents that may be coupled to the call center via the public switched telephone network.

In response to a customer call, an available agent is selected to take the call, and the call is connected to the selected agent. Initially upon connecting the customer call to the agent, it is determined whether voice is present in the connection from the agent to the customer within a predetermined time interval, which may be for example 3-6 seconds. The determination can be made by calculating the amount of energy in a stream of media packets from the agent, and comparing this value with a predetermined threshold. If no voice is determined to be present within the predetermined time interval, the customer call is promptly re-routed to another agent.

The technique can be used with both “local” agents (i.e. those physically present in the call center) and with “remote” agents (those who may be connected to the call center via the public switched telephone network (PSTN). In the case of remote agents in particular, a persistent call may have been established between the agent and the call center in advance of the customer call, to be used for a number of customer calls. In this case, the customer call is simply connected to the existing persistent call. The presence sensing technique is particularly beneficial because there is no possibility of a “ring no answer” event that would automatically result in re-routing of the call.

Various additional actions can be taken when this “agent not present” event has occurred. The initial agent may be marked as not available to accept subsequent customer calls, and the agent notified that the he/she has been marked unavailable. This makes the agent aware of the automatic re-routing effected by the system, and forces the agent to explicitly make himself/herself available again. The event may be reported to a supervisor, who may initiate contact with the agent or begin specific monitoring of the agent to ascertain whether the non-responsiveness recurs.

Additionally, the agent may be “polled” periodically via a voice connection to establish the agent's availability, such as by requesting that the agent speak or press a telephone button. This may be beneficial in periods of relatively low call volume. This technique can also be used after receiving the customer call but before routing it to the agent, so as to avoid sending calls to agents who are not present.

### BRIEF DESCRIPTION OF THE SEVERAL VIEWS OF THE DRAWING

The foregoing and other objects, features and advantages of the invention will be apparent from the following more particular description of preferred embodiments of the invention, as illustrated in the accompanying drawings in which like reference characters refer to the same parts throughout the different views:

FIG. 1 is a block diagram of a call center system employing a process of detecting the presence of a called party in accordance with the present invention;

FIG. 2 is a block diagram of a bridging server in the call center system of FIG. 1;

FIG. 3 is a flow diagram of a process by which calls are established in the call center system of FIG. 1;

FIG. 4 is a block diagram of the call center system of FIG. 1 with descriptive annotations corresponding to the steps of the process of FIG. 3;

FIG. 5 is a flow diagram of the process of detecting the presence of a called party utilized in the call center system of FIG. 1; and

FIG. 6 is a block diagram of an alternative call center system in which the presence detection process of FIG. 5 may be used.

### DETAILED DESCRIPTION

The disclosed methods and apparatus relate to the concept of detecting agent presence by monitoring the audio stream coming from an agent's phone during the first few seconds of a conversation with a customer. The agent can be using an IP phone or an analog phone. In the case of an IP phone, an automatic call distributor (ACD) monitors the audio coming from the agent. If the agent does not speak during the first few seconds of the conversation, the ACD redirects the call to another agent. It is also possible to monitor agents using traditional analog phones connected to the public switched telephone network (PSTN). In this case, the analog telephony signals from the agent's phone can be converted to an IP stream at the agent's end via an analog to IP coupler. Alternative, an “IP Bridging” service (described in more detail below) can call the agent at home and bridge the analog connection to a virtual IP phone. In this scenario, the agent presence analysis can be done either by the ACD or the IP Bridging service.

Additionally, “legacy” ACDs based on standard circuit-based telephony can implement agent presence detection using DSP techniques applied to proprietary analog or digital phones. The technique of listening to the audio from an agent phone during the first few seconds of the conversation applies equally well to both tradition analog technology as well as IP telephony.

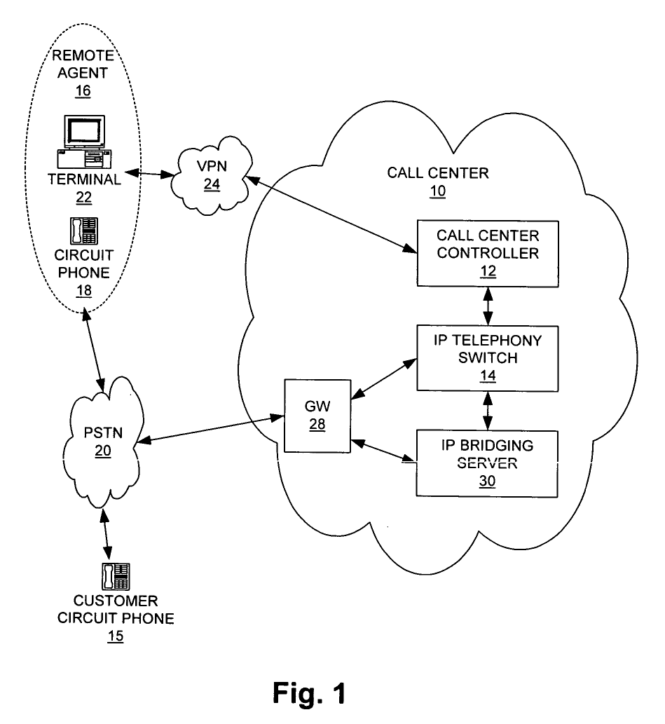

FIG. 1 shows a configuration for call center services as known in the art. An IP-based or packet-based call center 10 includes a call center controller 12 (which is essentially a so-called “automatic call distributor” or ACD) and a packet telephony switch shown as an Internet Protocol (IP) telephony switch 14. The call center 10 is configured to route incoming customer calls (originating from a customer circuit phone 15) to “remote” agents 16, in particular to an agent 16 that employs a circuit telephone 18 coupled to the public switched telephone network (PSTN) 20. The agent also has a terminal 22 coupled to the call center controller 12 via a virtual private network (VPN) 24. Such an agent 16 may be located at his/her home, for example, rather than at the same facility as the call center 10. This arrangement thus enables agents to “telecommute”, with the telephone connection being made via the PSTN 20 and a gateway 28, and the agent's “computer telephony interface” (CTI) connection being made via the VPN 24. The call center 10 also includes an IP bridging server 30 having connections to the IP telephony switch 14 and the gateway 28.

It will be appreciated that in general, a call center includes a large number of agents that handle incoming customer calls, but for present purposes it is sufficient to show only one such agent. The agent 16 is known as “remote” because the terminal 22 and the phone 18 are not coupled directly to the call center controller 12 and IP telephony switch 14, but rather through the VPN 24 and the PSTN 20 respectively.

During operation of the system of FIG. 1, the remote agent logs in to the call center controller 12 using the CTI application, which associates the agent's terminal 22 with a “proxy” telephone for the agent's circuit phone 18 (as described in more detail below). When the call center controller 12 receives a customer call and selects the agent to handle the call, it notifies the agent via the terminal 22 and routes the call to the proxy phone, which eventually results in a complete connection to the agent's circuit phone 18. The agent then engages in the telephone call with the customer, and generally utilizes the terminal 22 to obtain pertinent information such as customer identification information, order status information, etc. Once the telephone call is terminated, this fact is signaled to the call center controller 12 which then adds the agent 16 to a list of agents available to handle subsequent calls.

One of the desirable aspects of the system of FIG. 1 is the use of packet (IP) telephony within the call center 10. The above-mentioned “proxy” phones are identified by respective IP addresses, and are easily associated with terminals 22 that also are identified by IP addresses. Calls can be conferenced or re-routed easily by appropriate control of the IP telephony switch 14 and the IP bridging server 30. From the perspective of the call center controller 12, incoming customer calls are routed to IP addresses (proxy phones) of agents 16 that are known to be ready to accept such calls.

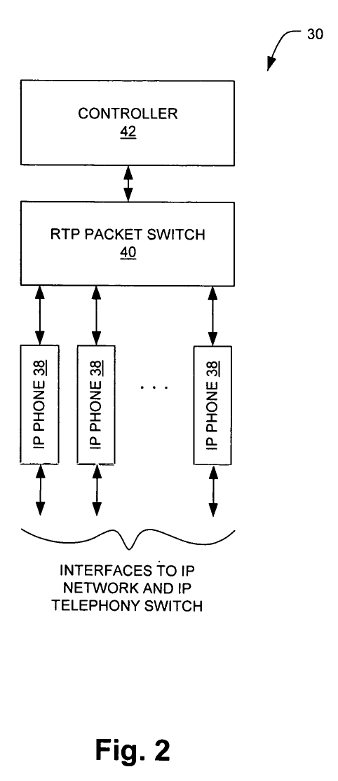

FIG. 2 shows the internal arrangement of the IP bridging server 30, which can be implemented for example using a standard server-type computer platform running a commercial operating system such as the Windows® operating system sold by Microsoft Corp. The IP bridging server 30 includes a plurality of emulated or “virtual” IP telephones (“IP phones”) 38 that are instantiated during initial operation of the IP bridging server 30. The IP phones 38 are independent software processes executing within the IP bridging server 30, each implementing at least the basic functionality associated with a conventional “hard” (i.e., physical) IP phone, including of course the ability to initiate and receive IP telephone calls using known IP telephony protocols. The IP phones 38 are logically connected to respective external interfaces that connect the IP bridging server 30 with the IP telephony switch 14 of FIG. 1. Each of the IP phones 38 is assigned a unique identifier by which it can be addressed from outside the IP bridging server 30. In one embodiment, each IP phone 38 has a unique port number that can be used in conjunction with a pre-assigned IP address shared by all the IP phones 38. Other identification schemes, including the use of unique IP addresses, are possible.

The IP bridging server 30 further includes one or more software processes that collectively implement a real-time protocol (RTP) packet switch 40. During operation, “connections” are established between respective pairs of the IP phones 38. These connections take the form of packet transfers by the RTP packet switch 40. That is, when a connection between two IP phones 38 has been established, the RTP packet switch 40 is responsible for forwarding RTP packets received at one of the IP phones 38 of the pair to the other IP phone 38 of the pair, and vice-versa. Thus, the RTP packet switch 40 can also be thought of as a packet relay mechanism.

The IP bridging server 30 further includes a controller 42 that is responsible for various control aspects of operation, including for example instantiating the virtual IP phones 38 and interacting with the call center controller 12 (FIG. 1) with respect to the assignment of port numbers to the IP phones 38 and their association with remote circuit phones, as described in more detail below. It will be appreciated that the controller 42 may communicate with the external world via a separate IP data interface not shown in FIG. 2.

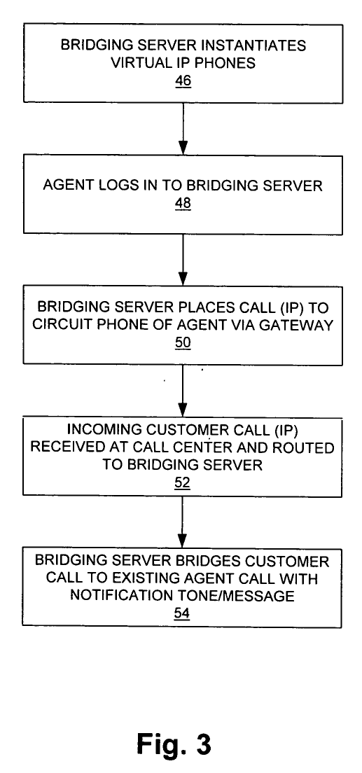

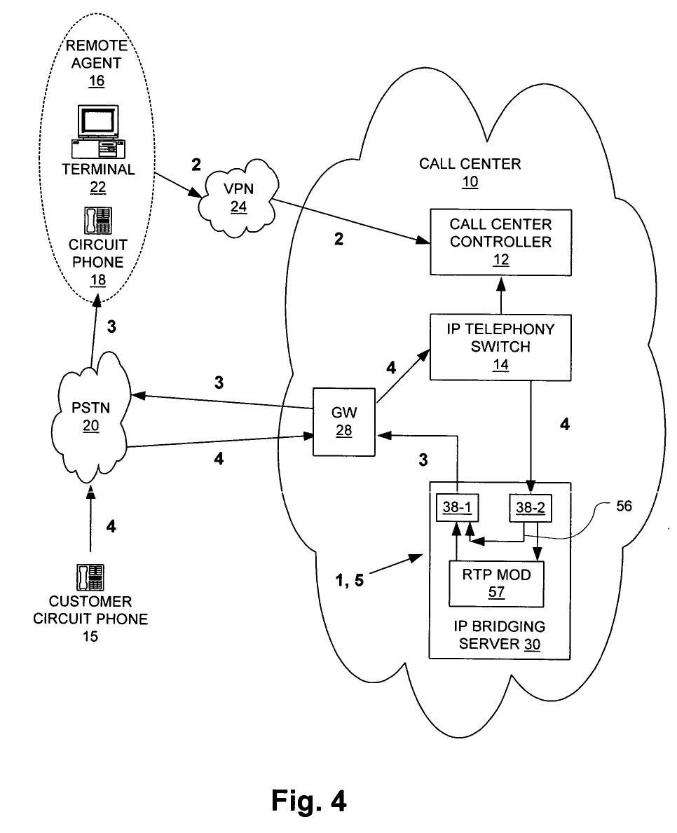

The call establishment operation of the call center arrangement of FIG. 1 is now described with reference to the flow diagram of FIG. 3 and the annotated block diagram of FIG. 4.

As shown at step 46 of FIG. 3 and indicated with a “1” in FIG. 4, the bridging server 30 initially instantiates a number of virtual IP phones 38. In FIG. 4, two of these phones 38-1 and 38-2 are shown. Each of these phones has an associated port number as described above.

At step 48 of FIG. 3 and indicated by “2” in FIG. 4, the remote agent 16 logs in via the VPN 24 to indicate his/her availability to accept calls. As part of the login, the remote agent 16 is associated within the call controller 12 with the IP address of an IP phone. In particular, the IP phone address is the address of the bridging server 30 with an appended port number of one of the virtual IP phones 38, specifically that of the phone 38-2 shown in FIG. 4. This address will have been previously configured.

As shown at step 50 of FIG. 3 and indicated as “3” in FIG. 4, the bridging server 30 responds to the agent's login by placing a call to the agent's circuit phone 18 via the gateway 28 and PSTN 20. This call is placed from the virtual IP phone 38-1. Once the agent answers the call, the call can be kept open for the duration of the agent's working session, which generally involves numerous individual calls.

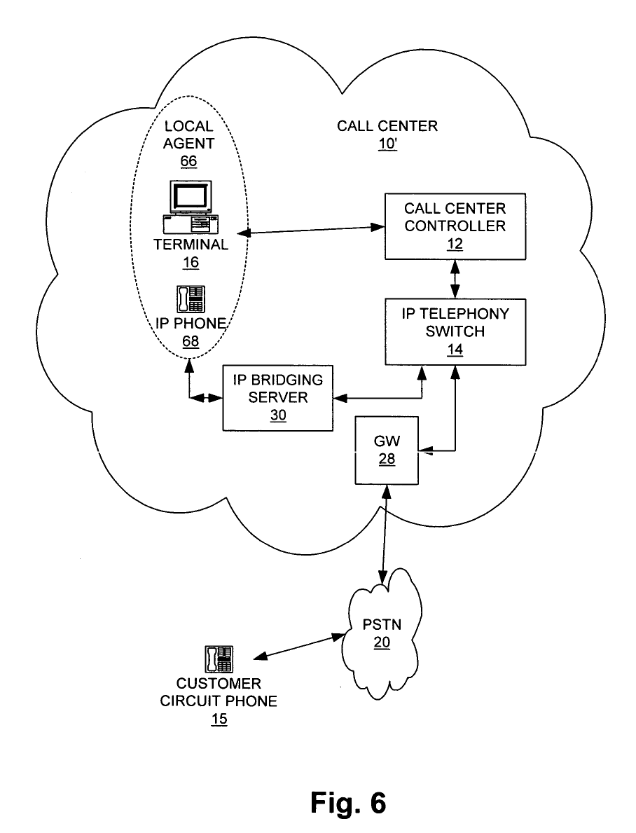

As shown at step 52 of FIG. 3 and indicated as “4” in FIG. 4, a customer then places a call to the call center 10, in this case from a circuit phone 15 via the PSTN 20 and gateway 28. The call center controller 12 routes the call to the IP address of the IP phone of an agent selected to handle the call. In the case of the system of FIGS. 1 and 4, however, this IP address is that of the virtual IP phone 38-2 within the bridging server 30. Because the path to the actual agent phone 18 is via the virtual IP phone 38-2, the virtual IP phone 38-2 can be viewed as a “proxy” for the agent phone 18. From the perspective of the call center controller 12, it is as though the agent is a local agent using a hard IP phone having the same address as the virtual IP phone 38-2 (an alternative configuration that is described below with reference to FIG. 6). In this respect, the bridging server 30 enables expanded functionality (e.g., support for remote agents) while retaining compatibility with IP-centric call center equipment, which can make adoption of the new functionality easier for vendors and customers alike.

As shown at step 54 and indicated as “5” in FIG. 4, the bridging server 30 responds to the incoming customer call at virtual IP phone 38-2 by “bridging” the two phones 38-1 and 38-2 together, i.e., establishing a connection for relaying the RTP packets carrying the call media from each phone to the other, thus completing a circuit between the customer circuit phone 15 and the agent circuit phone 18. This bridging, which is represented by a line segment 56 in FIG. 4, is implemented via the RTP packet switch 40 shown in FIG. 3 as configured by the controller 42 (also shown in FIG. 3).

As an alternative to the above operation, the bridging server may place a call to the agent 16 from the virtual IP phone 38-1 upon receiving each incoming customer call, rather than doing so upon the agent's logging in and maintaining the agent call for multiple customer calls. In this case, it may be unnecessary to overwrite the initial RTP stream as described above, because the agent will be notified by the new call.

As another alternative, the bridging server 30 may be capable of accepting the agent's log-in over a telephone connection, using a program for interpreting the dual-tone multiple-frequency (DTMF) tones generated by a circuit telephone. In this case, the agent 16 logs in by calling the bridging server 30 and then executing the log-in procedure.

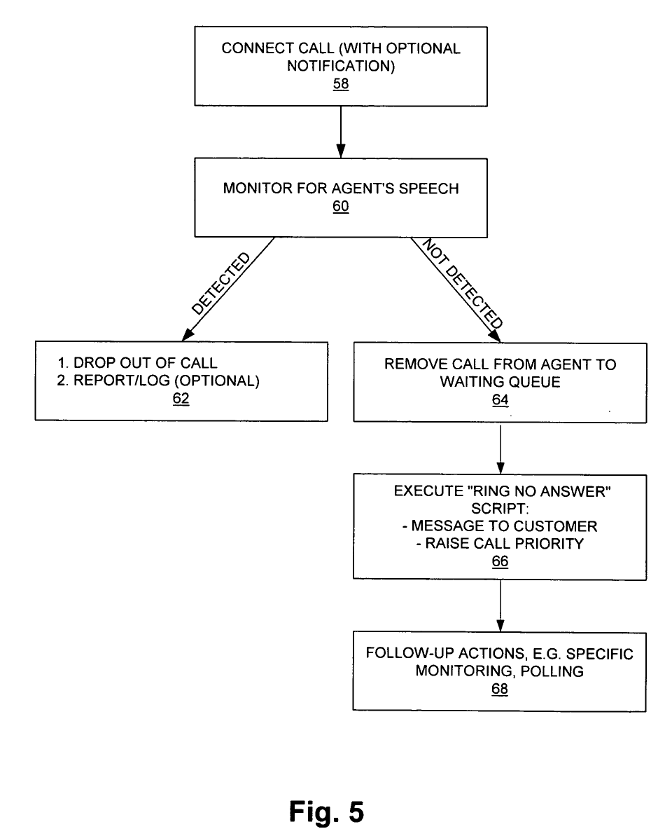

FIG. 5 shows a process by which the bridging server 30 determines whether the remote agent 16 is actually present, for the purposes of re-routing a customer call if necessary. The presence detection is based on determining whether the agent starts to speak to the customer within a predetermined time period, such as 3-6 seconds for example.

At step 58, the bridging server 30 connects the call, as is described above with reference to FIGS. 3 and 4. The bridging server 30 can optionally provide a notification to the agent 16 that he/she is receiving a new customer call. This notification may take the form, for example, of a pre-recorded message or a tone played out to the agent's phone 18. The notification may also include information identifying the customer to the agent, which may have been obtained, for example, from records within the call center 10 based on the telephone number of the calling party.

At step 60, the bridging server 30 monitors the RTP stream from the remote agent 16 for the presence of energy indicating that the agent is speaking. In general, this process involves calculating the energy of the media carried in the RTP packets over an appropriate interval and comparing the calculated value with a predetermined threshold. An appropriate interval is likely in the range of 3-6 seconds, and may be configurable. If the line is normally silent in the absence of speech from the agent, then the threshold will be a relatively low value. In some cases, so-called “comfort noise” may have been injected into the line for the customer's benefit, and if so the calculation may involve a relatively higher threshold based on the level of the comfort noise. That is, the total energy being calculated is that of the comfort noise plus any agent speech, and this level would have to be higher than the average comfort noise level to indicate that speech is also present. The voice detection algorithm also looks for signals with tonality properties which separate voice from tones (such as DTMF or other signaling tones).

If the monitoring of step 60 indicates that speech is present, then the process proceeds to step 62. The monitoring function within the bridging server 30 drops out of the call. If it is desired at the system level, the successful detection of agent speech may be logged or otherwise reported to a supervisory function within the call center 10.

If the monitoring of step 60 indicates that speech is not present, it is inferred that the agent is either not present or for some other reason is not responding to the customer. The process proceeds to step 64, at which the call is removed from the agent back to a queue for waiting calls within the call center 10. The call center controller 12 takes these actions upon receiving a signal from the bridging server 30 that this “agent not present” event has occurred.

At step 66, a script is executed that may be the same as that executed in a “ring no answer” scenario. Among other possible call-specific actions, the script can play a message to the customer indicating that there is a connection problem and that they will be handled by the next available agent, and can raise the priority of this customer call on the queue so that the customer receives the next available agent.

At step 68, various follow-up actions can be taken. The agent is marked NOT READY so that no further calls are routed to him/her. This results in a CTI message to the agent indicating that a call was removed from him/her due to lack of speaking. Also, the agent is forced to manually become READY again via the CTI.

Further, the occurrence of an “agent not present” event can be tracked by reporting at an agent level with a separate event. Supervisors can monitor which agents have these events and how frequently these events occur for performance tracking reasons. The system can monitor whether a particular agent has multiple such events in the course of a specified time period, and if so a supervisor can then be connected to this agent to determine the source of the problem. Additionally, the system may monitor the activity of the agent's terminal 22, and the activity information may be made available to the supervisor. If the terminal monitoring indicates that the agent was actually present (i.e., agent is using the mouse or keyboard) at the time an “agent not present” event occurred, this might indicate that the agent is acting inappropriately by receiving calls but not responding to the customer, and appropriate supervisory action can be taken.

In periods of low incoming call volume, which can be determined by monitoring the depth of the call queue and/or the number of available agents, a ‘polling’ mechanism can be employed which places calls to inactive agents and prompts them to reply by pressing a particular DTMF digit. In the event that an agent does not reply to this prompt, the system assumes that he/she has left his/her post, and the actions of step 68 can be taken.

FIG. 6 shows an alternative call center configuration 10′ employing a local agent 66. The agent 66 is known as “local” because the terminal 16 and the agent phone 68 are coupled directly to the call center controller 12 and the bridging server 30. It will be appreciated that in most instances a number of local agents are located together in a single call center facility. Additionally, the configurations 10′ and 10 (FIG. 1) are not mutually exclusive—it is possible (and perhaps likely) that a call center will have both local and remote agents.

The primary difference between the system of FIG. 6 using the call center 10′ and the system of FIG. 1 using the call center 10 is the nature of the link between the call center 10′ and the agent phone 68. In the system of FIG. 6, this is an all-packet link, whereas in the system of FIG. 1 this is a hybrid packet and circuit link as described above. However, the agent present monitoring process of FIG. 5 can be the same in both systems.

Although in the foregoing, the agent presence detection occurs immediately after a call has been connected to the agent, presence detection can also be performed prior to sending a call to an agent, either as an alternative or in addition to post-connection presence detection. For example, a call can be placed to a remote agent 16 via the call center controller 12 to verify presence. This type of scenario might only play out if an agent hasn't received a call in the last 15 minutes or more. Using such pre-call presence verification would reduce or eliminate the need for re-routing customer calls due to agent absence. A separate call would not be necessary when a persistent call via the bridging server 30 is used, as described above. The agent can simply be asked to press a button on his/her phone or speak into the headset to indicate that he/she is available for a call.

Those skilled in the art will appreciate that embodiments and variations of the present invention other than those explicitly disclosed herein are possible. It is to be understood that modifications to the methods and apparatus disclosed herein are possible while still achieving the objectives of the invention, and such modifications and variations are within the scope of this invention. Accordingly, the scope of the present invention is not to be limited by the foregoing description of embodiments of the invention, but rather only by the claims appearing below.

What is claimed is:

1. A method of handling a customer call in a call center, comprising:
in response to the customer call, (1) selecting an available first agent to take the call, and (2) connecting the customer call to the first agent;
initially upon connecting the customer call to the first agent, determining whether voice is present in the connection from the first agent to the customer within a predetermined time interval; and
if no voice is determined to be present within the predetermined time interval, effecting the prompt re-routing of the customer call to an available second agent.

2. A method according to claim 1, wherein determining whether voice is present comprises:
calculating the level of energy in a stream of media packets from the first agent; and
comparing the calculated energy level with a predetermined threshold value.

3. A method according to claim 1, wherein a persistent call between the agent and the call center has been established in advance of the customer call to be used for a plurality of customer calls, and wherein connecting the customer call to the agent comprises connecting the customer call to the persistent call.

4. A method according to claim 1, further comprising, upon re-routing the customer call to the second agent, marking the first agent as not available to accept subsequent customer calls.

5. A method according to claim 4, further comprising notifying the first agent that the first agent has been marked unavailable.

6. A method according to claim 1, further comprising, if no voice is determined to be present during the predetermined interval, reporting the occurrence of an “agent not present” event to a supervisor.

7. A method according to claim 6, further comprising:
obtaining activity information indicating whether the first agent is present upon completing the connection between the first agent and the customer; and
including such activity information in the reporting to the supervisor.

8. A method according to claim 7, wherein the activity information includes information about usage by the first agent of a user input device of a computer terminal used by the first agent.

9. A method according to claim 6, further comprising:
determining whether other “agent not present” events occur for this agent within a predetermined time interval, and if so then reporting this determination to the supervisor.

10. A method according to claim 1, further comprising, in periods of relatively low volume of customer calls, periodically polling the agent via a voice connection to the agent to determine whether the agent is present.

11. A method according to claim 10, wherein polling the agent comprises:
playing a voice message to the agent via the voice connection requesting that the agent provide a requested audible indication; and
determining whether the requested audible indication is subsequently present on the voice connection from the agent.

12. A method according to claim 11, wherein the requested audible indication is speech.

13. A method according to claim 11, wherein the requested audible indication is a dual-tone-multiple-frequency tone.

14. A method according to claim 1, further comprising:
after selecting the first agent and before connecting the customer call to the first agent, playing a voice message to the agent via a voice connection requesting that the agent provide a requested audible indication of the agent's presence;
determining whether the requested audible indication is subsequently present on the voice connection from the agent;
if the requested audible indication is determined to be present, then connecting the customer call to the agent; and
if the requested audible indication is determined not to be present, then selecting another agent to take the call.

15. A call center comprising one or more computerized devices, the computerized devices being collectively operative to perform the steps of:
in response to a customer call, (1) selecting an available first agent to take the call, and (2) connecting the customer call to the first agent;
initially upon connecting the customer call to the first agent, determining whether voice is present in the connection from the first agent to the customer within a predetermined time interval; and
if no voice is determined to be present within the predetermined time interval, promptly re-routing the customer call to an available second agent.

16. A call center according to claim 15, wherein the computerized devices are operative when determining whether voice is present to perform the steps of:
calculating the level of energy in a stream of media packets from the first agent; and
comparing the calculated energy level with a predetermined threshold value.

17. A call center according to claim 15, wherein a persistent call between the agent and the call center has been established in advance of the customer call to be used for a plurality of customer calls, and wherein the computerized devices are operative when connecting the customer call to the agent to perform the step of connecting the customer call to the persistent call.

18. A call center according to claim 15, wherein the computerized devices are further operative, upon re-routing the customer call to the second agent, to perform the step of marking the first agent as not available to accept subsequent customer calls.

19. A call center according to claim 18, wherein the computerized devices are further operative, upon marking the first agent as not available, to perform the step of notifying the first agent that the first agent has been marked unavailable.

20. A call center according to claim 15, wherein the computerized devices are further operative, if no voice is determined to be present during the predetermined interval, to perform the step of reporting the occurrence of an “agent not present” event to a supervisor.

21. A call center according to claim 20, wherein the computerized devices are further operative to perform the steps of:
obtaining activity information indicating whether the first agent is present upon completing the connection between the first agent and the customer; and
including such activity information in the reporting to the supervisor.

22. A call center according to claim 21, wherein the activity information includes information about usage by the first agent of a user input device of a computer terminal used by the first agent.

23. A call center according to claim 20, wherein the computerized devices are further operative to perform the step of:
determining whether other “agent not present” events occur for this agent within a predetermined time interval, and if so then reporting this determination to the supervisor.

24. A call center according to claim 15, wherein the computerized devices are further operative, in periods of relatively low volume of customer calls, to perform the step of periodically polling the agent via a voice connection to the agent to determine whether the agent is present.

25. A call center according to claim 24, wherein the computerized devices are further operative, when polling the agent, to perform the steps of:
playing a voice message to the agent via the voice connection requesting that the agent provide a requested audible indication; and
determining whether the requested audible indication is subsequently present on the voice connection from the agent.

26. A call center according to claim 25, wherein the requested audible indication is speech.

27. A call center according to claim 25, wherein the requested audible indication is a dual-tone-multiple-frequency tone.

28. A call center according to claim 15, wherein the computerized devices are further operative to perform the steps of:
after selecting the first agent and before connecting the customer call to the first agent, playing a voice message to the agent via a voice connection requesting that the agent provide a requested audible indication of the agent's presence;
determining whether the requested audible indication is subsequently present on the voice connection from the agent;
if the requested audible indication is determined to be present, then connecting the customer call to the agent; and
if the requested audible indication is determined not to be present, then selecting another agent to take the call.
